(19) United States
(12) Patent Application Publication
(10) Pub. No.: US 2017/0067755 A1
(43) Pub. Date: Mar. 9, 2017

(54) Motor Actuator, Method of Processing Motor Actuator, and Method of Inspecting Motor Actuator

(71) Applicant: TGK CO., LTD., Tokyo (JP)

(72) Inventors: Hitoshi Tsuda, Tokyo (JP); Katsushi Arata, Tokyo (JP); Yasuaki Kaneko, Tokyo (JP)

(21) Appl. No.: 15/247,832

(22) Filed: Aug. 25, 2016

(30) Foreign Application Priority Data
Sep. 7, 2015 (JP) 2015-175636

(51) Int. Cl. G01D 5/20; H01R 13/52; H01R 12/71

(52) U.S. Cl. CPC G01D 5/20; H01R 12/714; H01R 13/5213

(57) ABSTRACT

A motor actuator includes a housing that contains a motor, a sensor contained in the housing, and a transmission path capable of continuously transmitting a detection signal generated by the sensor. The housing has an insertion hole formed therein, and the insertion hole is capable of receiving a probe for taking out the detection signal from the transmission path. The detection signal of the sensor can be directly taken out from the transmission path through the probe. Accordingly, the detection signal of the sensor can be measured continuously with respect to a temporal change, and the accuracy in inspecting the output characteristics of the sensor can be increased.

### CLAIM OF PRIORITY

This application claims priority to Japanese Patent Application No. JP2015-175636, filed on Sep. 7, 2015, of which is incorporated herein by reference.

### BACKGROUND OF THE INVENTION

1. Field of the Invention

The present invention relates to motor actuators for use in in-vehicle systems or the like, methods of processing motor actuators, and methods of inspecting motor actuators.

2. Description of the Related Art

A motor actuator (hereinafter, referred to as an actuator) is used as a driving source for a door of an air conditioning apparatus, a power window, or the like in an in-vehicle system. An actuator includes an electric motor, an output shaft rotationally driven by the electric motor, a rotation sensor for detecting the rotational position of the output shaft, and a control portion for controlling the electric motor (see Reference (1) in the following Related Art List). The control portion controls the electric motor in accordance with an operation instruction transmitted from an electronic control portion (ECU) so that the rotational position detection value output from the rotation sensor approaches a target value.

(1) Japanese Unexamined Patent Application Publication No. 2013-183554.

In this type of in-vehicle systems, a plurality of actuators are controlled integrally by the ECU. In such an in-vehicle system, serial communication, such as Local Interconnect Network (LIN), may be used in order to reduce the number of electric wires for connecting the plurality of actuators. In this serial communication, data is exchanged between the plurality of actuators and the ECU with the use of a single communication line.

After an actuator is assembled, the actuator may need to be inspected in order to check the output characteristics of the rotation sensor. This inspection is carried out, for example, by measuring the signal level of a detection signal that is output from the rotation sensor during the rotational position of the output shaft being changed. Therefore, when the output characteristics of the rotation sensor are inspected, a detection signal of the rotation sensor needs to be taken out from the actuator to the outside.

When a detection signal is to be taken out from the actuator having the aforementioned serial communication function, a conceivable technique is to output a detection signal through a communication line with the use of a communication protocol for the serial communication used by the actuator. However, with this type of communication protocol for the serial communication, a detection signal can be output from the actuator to the outside only in a case in which an operation instruction requesting for a current detection signal is transmitted to the actuator from an external control apparatus. Thus, only an intermittent detection signal with respect to a temporal change can be taken out from the actuator, and a continuous detection signal with respect to the temporal change cannot be taken out. Accordingly, when the inspection is carried out through the above-described technique, favorable detection accuracy may be hard to obtain.

### SUMMARY OF THE INVENTION

The present invention has been made in view of such a problem, and one of purposes thereof is to provide a technique by which the inspection accuracy can be increased when inspecting output characteristics of a sensor inside a housing.

An aspect of the present invention for solving the above-described problem provides a motor actuator. The motor actuator includes a housing that contains a motor, a sensor contained in the housing, and a transmission path capable of continuously transmitting a detection signal generated by the sensor. The housing has an insertion hole formed therein, and the insertion hole is capable of receiving a probe for taking out the detection signal from the transmission path.

According to this aspect, the detection signal of the sensor can be directly taken out from the transmission path through the probe. Accordingly, the detection signal of the sensor can be measured continuously with respect to a temporal change, and the accuracy in inspecting the output characteristics of the sensor can be increased.

### BRIEF DESCRIPTION OF THE DRAWINGS

FIG. 1 is a configuration diagram illustrating an actuator and an inspection apparatus for use in an inspection method according to a first embodiment;

FIG. 2 is a block diagram illustrating functionality of the actuator and the inspection apparatus according to the first embodiment;

FIG. 3 is a perspective view of the actuator according to the first embodiment;

FIG. 4 is an exploded perspective view of the actuator according to the first embodiment;

FIG. 5 is an exploded perspective view illustrating a rotation sensor and a control circuit board of the actuator according to the first embodiment;

FIG. 6 is an outline drawing of the front surface side of the control circuit board according to the first embodiment;

FIG. 7 is a sectional view illustrating a probe insertion hole in the actuator according to the first embodiment;

FIG. 8 illustrates the shape of a probe abutting portion according to the first embodiment, as viewed from one side in the axial direction of the probe insertion hole;

FIG. 9 is a graph illustrating a relationship between the rotational position of an output shaft and the signal level of a detection signal of a rotation sensor;

FIG. 10A illustrates a state of the actuator in the midway of a processing method according to the first embodiment;

FIG. 10B illustrates the actuator processed through the processing method;

FIG. 11 is a sectional view illustrating an actuator according to a second embodiment;

FIG. 12 is a block diagram illustrating functionality of an actuator and an inspection apparatus according to a third embodiment; and

FIG. 13 is a schematic diagram illustrating a configuration of a portion around a connector portion of the actuator according to the third embodiment.

### DETAILED DESCRIPTION OF THE INVENTION

The invention will now be described by reference to the preferred embodiments. This does not intend to limit the scope of the present invention, but to exemplify the invention.

Hereinafter, in embodiments and modifications, identical constituent elements are given identical reference characters, and duplicate descriptions thereof will be omitted. In addition, in each of the drawings, constituent elements are partially omitted as appropriate for simplifying the description.

### First Embodiment

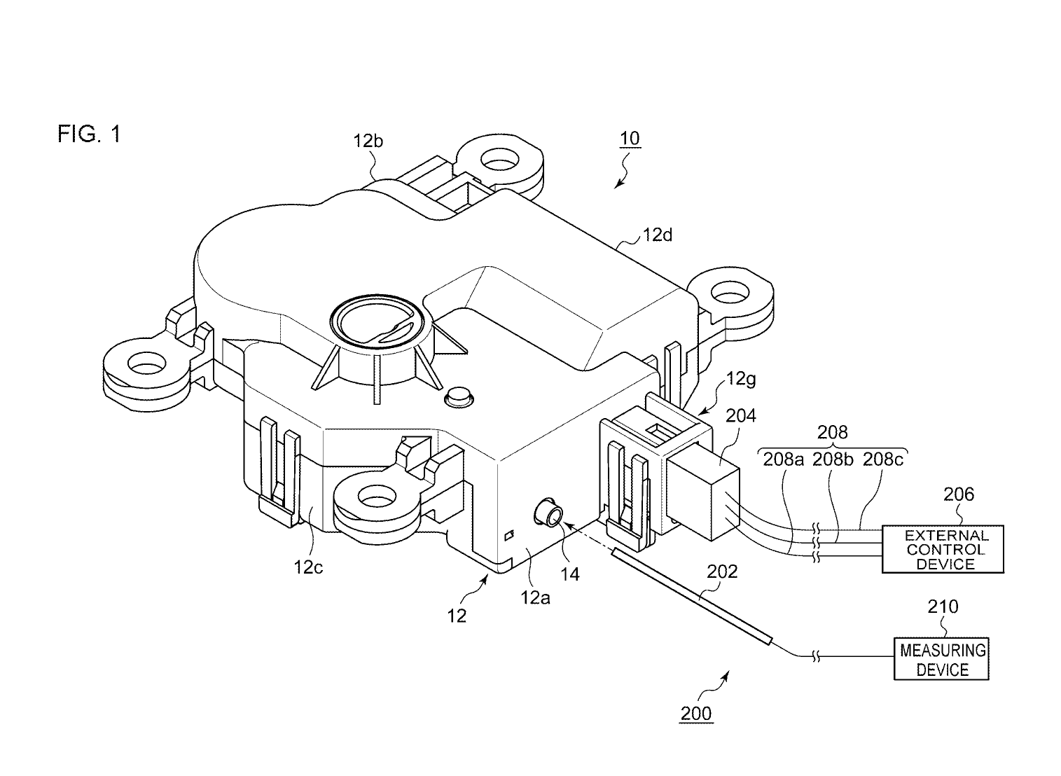

FIG. 1 is a configuration diagram illustrating an actuator 10 and an inspection apparatus 200 for use in an inspection method according to a first embodiment.

The overview of the inspection method will be described. In the inspection method, a probe 202 of the inspection apparatus 200 is inserted into a probe insertion hole 14 formed in a housing 12 of the actuator 10. A transmission path capable of continuously transmitting a detection signal generated by a sensor is disposed inside the housing 12, and the leading end portion of the probe 202 makes contact with a conductor constituting a portion of the transmission path. The detection signal of the sensor can be directly taken out from the probe 202, and the detection signal of the sensor can be measured continuously by a measuring device 210 of the inspection apparatus 200.

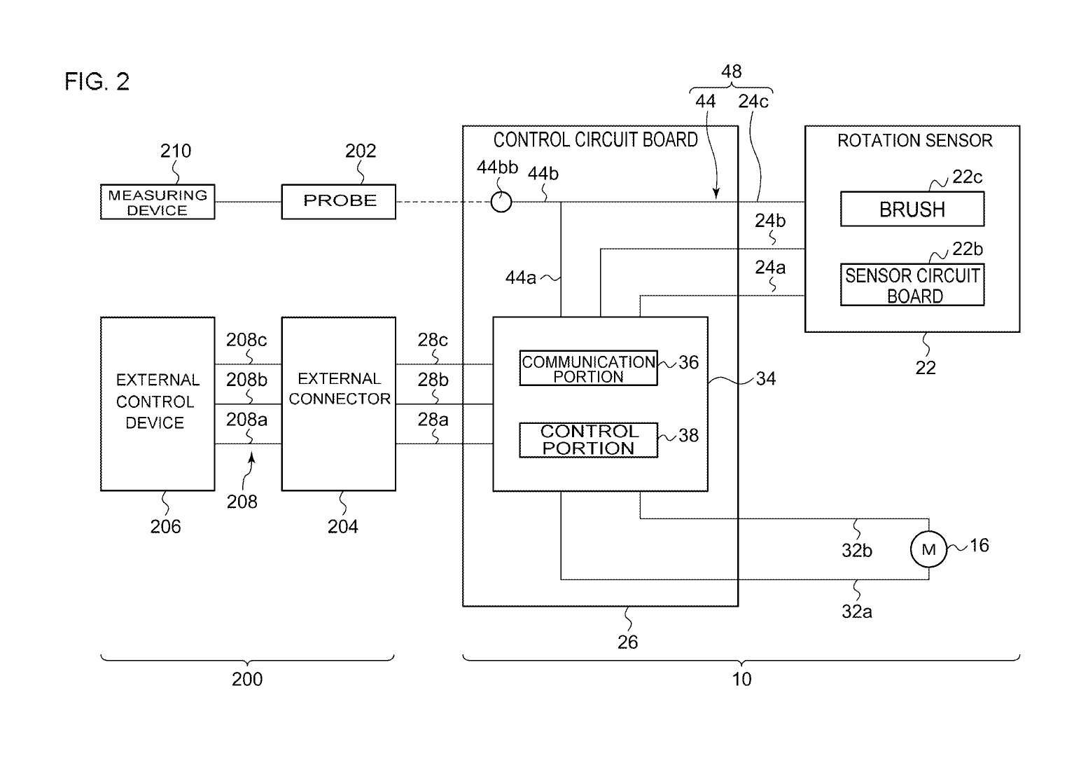

FIG. 2 is a block diagram illustrating functionality of the actuator 10 and the inspection apparatus 200.

As illustrated in FIGS. 1 and 2, the inspection apparatus 200 includes an external connector 204, an external control device 206, and a wiring harness 208. The external connector 204 is detachably mounted to a connector portion 12g formed on the housing 12 of the actuator 10. The external control device 206 controls a control portion 38 (described later) of the actuator 10 from the outside. The wiring harness 208 connects the external control device 206 and the external connector 204. The external control device 206 is constituted by a computer in which a central processing unit (CPU), a read-only memory (ROM), a random-access memory (RAM), and so on are combined. The wiring harness 208 includes a ground line 208a that serves as a ground potential, a power-supply line 208b for supplying power from the external control device 206, and a communication line 208c that constitutes a portion of a communication path for transmitting and receiving data to and from the external control device 206.

The inspection apparatus 200 further includes the probe 202 for taking out a detection signal (described later) generated by a rotation sensor 22 (described later) of the actuator 10, and the measuring device 210 for measuring the signal level of the detection signal output from the probe 202. The measuring device 210 is a voltmeter that measures the voltage level of the detection signal output from the probe 202. The measuring device 210 measures, as the voltage level, a potential difference of the detection signal relative to the ground potential.

The actuator 10 will now be described.

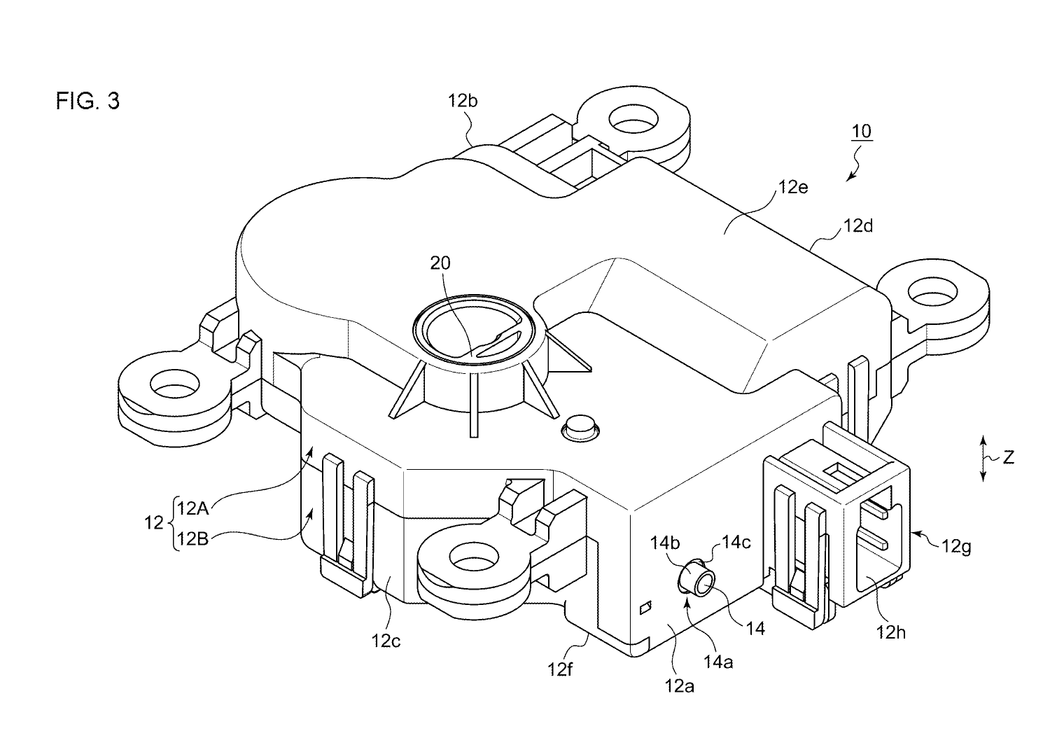

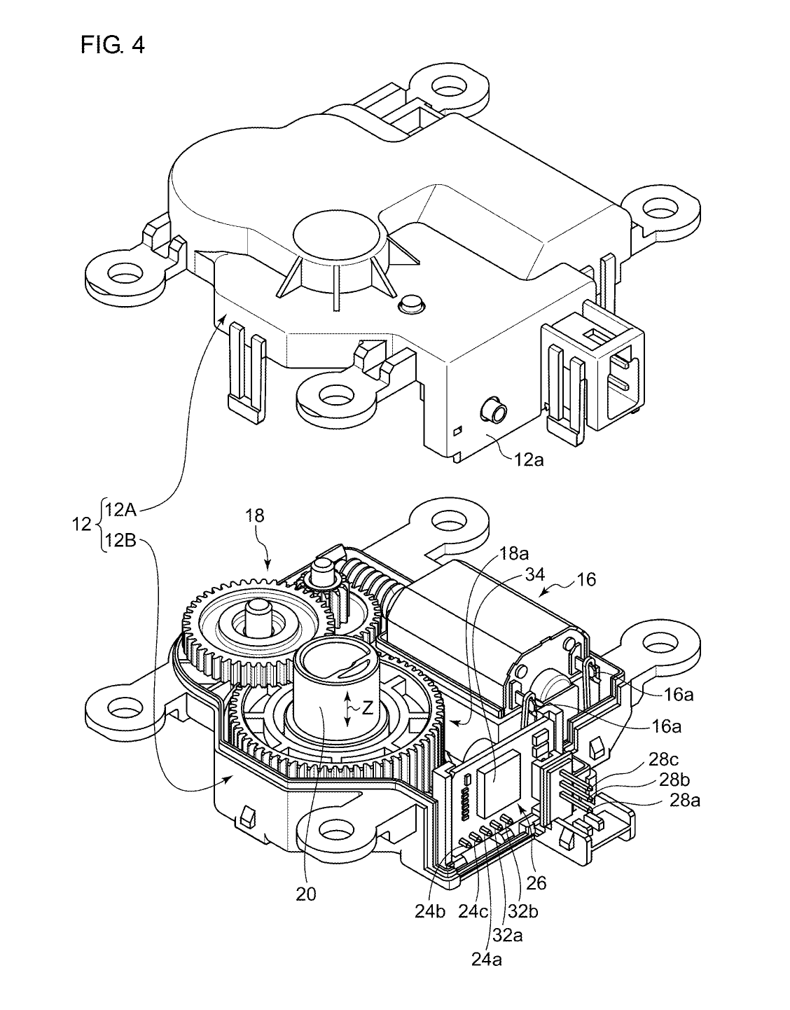

FIG. 3 is a perspective view of the actuator 10, and FIG. 4 is an exploded perspective view of the actuator 10. Although a characteristic feature of the actuator 10 lies in the probe insertion hole 14 of the housing 12 as described above, the peripheral structure will be described first.

The actuator 10 includes the housing 12. The housing 12 is formed of a resin material. The housing 12 contains internal components, such as an electric motor 16, the rotation sensor 22, and a control circuit board 26, which will be described later.

The housing 12 is constituted by an upper housing member 12A (first housing member) and a lower housing member 12B (second housing member). Each of the housing members 12A and 12B has a shape obtained by dividing the housing 12 in a height direction Z. The height direction Z corresponds to the axial direction of an output shaft 20, which will be described later. The housing members 12A and 12B are detachably attached to each other through a snap-fit method or the like.

As illustrated in FIG. 3, the housing 12 includes four side surface portions 12a, 12b, 12c, and 12d that are provided around the directional axis along the height direction Z and two side surface portions 12e and 12f that are provided on two sides in the height direction Z. Among the plurality of side surface portions 12a-12d of the housing 12, the side surface portion 12a is provided with the connector portion 12g to which the external connector 204 (see FIG. 1) can be mounted. The connector portion 12g has a cylindrical shape that projects toward the outside from the side surface portion 12a. A connector insertion hole 12h is formed in the connector portion 12g, and the external connector 204 can be inserted into the connector insertion hole 12h. Hereinafter, with regard to the positional relationship of the housing 12, the side where the connector portion 12g is provided is set to be the front side. The side surface portion 12a of the housing 12 is referred to as a front side surface portion 12a, and the side surface portion 12b, which is on the side opposite to the front side surface portion 12a, is referred to as a back side surface portion 12b.

As illustrated in FIG. 4, the actuator 10 further includes the electric motor 16, a speed-reduction mechanism 18, and the output shaft 20. The speed-reduction mechanism 18 can transmit the rotary power output from a motor shaft (not illustrated) of the electric motor 16 while reducing the speed thereof. The output shaft 20 is rotationally driven by the rotary power transmitted from the speed-reduction mechanism 18. The electric motor 16 is a DC motor. The speed-reduction mechanism 18 is a gear mechanism in which a screw gear and a spur gear are combined and includes an output gear 18a that is a final-stage spur gear. The output shaft 20 is rotatably supported by a bearing portion (not illustrated) of the housing 12 and is provided so as to be rotatable along with the output gear 18a. One end portion (an end portion on the lower side in the drawing) of the output shaft 20 projects from the housing 12 to the outside, and the rotary power is output from the one end portion to an apparatus to be driven. The apparatus to be driven is, for example, a door that opens or closes an airflow passage of an air conditioning apparatus.

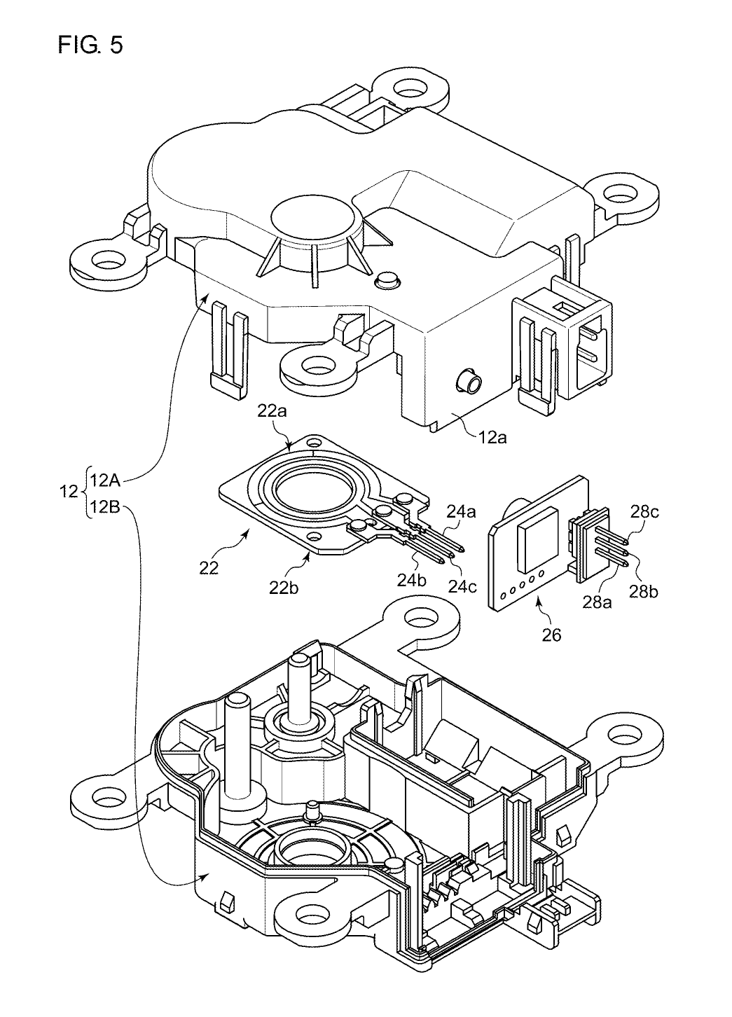

FIG. 5 is an exploded perspective view illustrating the rotation sensor 22 and the control circuit board 26 of the actuator 10.

As illustrated in FIGS. 2 and 5, the actuator 10 further includes the rotation sensor 22 for detecting the rotational position of the output shaft 20. The rotation sensor 22 includes a sensor circuit board 22b (hereinafter, simply referred to as a sensor board 22b as well) in which a conductive detection pattern 22a is formed, and a brush 22c (not illustrated in FIG. 5) that makes contact with the detection pattern 22a. The rotation sensor 22 is disposed between the output gear 18a and the base of the lower housing member 12B. The sensor board 22b is disposed in the housing 12 in a state in which the position thereof is retained, and the brush 22c is provided so as to be rotatable along with the output shaft 20 and the output gear 18a. The detection pattern 22a and the brush 22c constitute a variable resistor (potentiometer).

Three sensor terminals 24a-24c are connected to the sensor board 22b. The sensor terminals 24a-24c include a ground sensor terminal 24a that serves as a ground potential, a power-supply sensor terminal 24b for applying a sensor driving voltage to the detection pattern 22a, and an output sensor terminal 24c for outputting a detection signal from the detection pattern 22a.

When the output shaft 20 rotates while the sensor driving voltage is being applied to the power-supply sensor terminal 24b, the position of the contact point between the brush 22c and the detection pattern 22a changes, and a voltage signal whose magnitude varies in accordance with the rotational position of the output shaft 20 is output from the output sensor terminal 24c. This voltage signal constitutes a detection signal that indicates the rotational position of the output shaft 20. In this manner, the rotation sensor 22 has a function of generating a detection signal that indicates the rotational position of the output shaft 20 and outputting the detection signal through the output sensor terminal 24c. The rotation sensor 22 of this type is well known, and thus detailed description thereof will be omitted in the present specification.

As illustrated in FIGS. 2, 4, and 5, the actuator 10 further includes the control circuit board 26 (hereinafter, simply referred to as the control board 26) for controlling the electric motor 16. The control board 26 is disposed on an inner side of the front side surface portion 12a of the housing 12 in a state in which the position of the control board 26 inside the housing 12 is retained.

Three connector terminal 28a, 28b, and 28c are connected to the control board 26. The connector terminals 28a-28c include a ground connector terminal 28a that serves as a ground potential and a power-supply connector terminal 28b for supplying power from the external control device 206. In addition, the connector terminals 28a-28c include a communication connector terminal 28c that constitutes a portion of the communication path for transmitting and receiving data to and from the external control device 206.

As illustrated in FIGS. 2 and 4, two relay terminals 32a and 32b are connected to the control board 26. The relay terminals 32a and 32b are connected to a pair of motor terminals 16a of the electric motor 16. The relay terminals 32a and 32b are used to supply, to the electric motor 16, a motor driving voltage for normally rotating or reversely rotating the electric motor 16.

An IC chip 34 serving as a circuit element is mounted to the control board 26. The IC chip 34 serves as a circuit element that constitutes a communication portion 36 for communicating with the external control device 206 and the control portion 38 for controlling the electric motor 16 and the rotation sensor 22.

The communication portion 36 transmits and receives data to and from the external control device 206 through serial communication (multiplex communication) with the use of the single communication line 208c in accordance with a predetermined communication protocol. In this communication protocol, a master-slave communication system is used. In this communication system, the external control device 206 is the master and the actuator 10 is the slave. Under this communication protocol, the control portion 38 of the actuator 10 operates in accordance with an operation instruction transmitted from the external control device 206. This communication protocol is, for example, Local Interconnect Network (LIN) or Controller Area Network (CAN).

Upon being supplied with power from the external control device 206, the control portion 38 generates a motor driving voltage and supplies the motor driving voltage to the electric motor 16, and generates a sensor driving voltage and supplies the sensor driving voltage to the rotation sensor 22.

In addition, the control portion 38 controls the electric motor 16 in accordance with a rotational operation instruction, transmitted from the external control device 206, for rotating the electric motor 16. Specifically, the control portion 38 controls the direction in which the electric motor 16 rotates and the number of rotations of the electric motor 16 so that the rotational position detection value indicated by the detection signal output from the rotation sensor 22 approaches the rotational position instruction value included in the rotational operation instruction transmitted from the external control device 206.

The control portion 38 receives an analog-value detection signal from the rotation sensor 22 through a transmission path 48 (described later). The control portion 38 subjects the analog-value detection signal to predetermined processing including A/D conversion processing and acquires a digital-value detection signal. The control portion 38 carries out the control of the electric motor 16 and so on with the use of the digital-value detection signal.

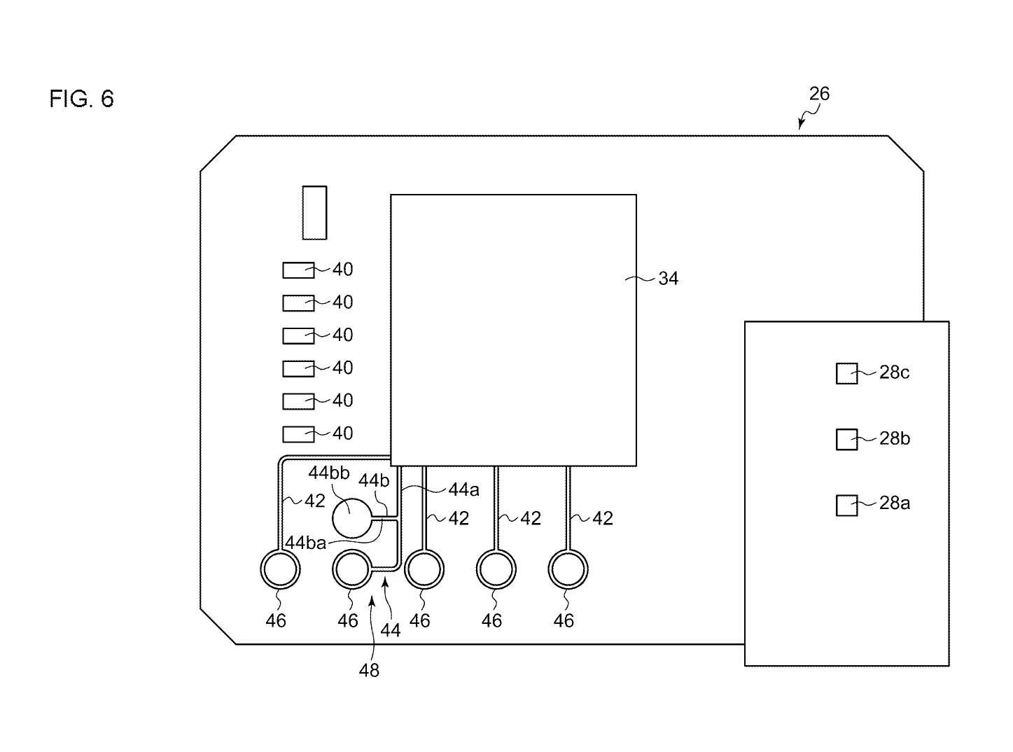

FIG. 6 is an outline drawing of the front surface side of the control board 26.

As illustrated in FIGS. 2 and 6, a plurality of circuit elements 34 and 44 including the IC chip 34 are mounted on the front surface of the control board 26. And a plurality of conductor patterns 42 and 44 for providing electrical continuity to the sensor terminals 24a-24c and so on are formed on the front surface of the control board 26. FIG. 6 illustrates only the plurality of conductor patterns 42 and 44 for providing electrical continuity between the IC chip 34 and the sensor terminals 24a-24c and relay terminals 32a and 32b. A through-hole electrode 46 is formed at one end portion of each of the conductor patterns 42, and the terminals 24a-24c, 32a, and 32b are inserted into the through-hole electrodes 46 and soldered (not illustrated) for electrical continuity.

The conductor patterns 42 and 44 include a transmission pattern 44 that constitutes a portion of the transmission path 48 capable of continuously transmitting a detection signal generated by the rotation sensor 22. The transmission path 48 is constituted by the output sensor terminal 24c of the rotation sensor 22 and the transmission pattern 44, and an analog-value detection signal generated by the rotation sensor 22 is transmitted to the transmission path 48. The transmission pattern 44 provides electrical continuity between the output sensor terminal 24c of the rotation sensor 22 and the IC chip 34.

The transmission pattern 44 includes a primary transmission pattern 44a that constitutes a portion of a primary transmission path for transmitting a detection signal from the rotation sensor 22 (from the through-hole electrode 46 in FIG. 6) to the IC chip 34, and an auxiliary transmission pattern 44b that constitutes an auxiliary transmission path formed by a portion that has branched off from the primary transmission pattern 44a. Assuming a side of the position at which the auxiliary transmission pattern 44b branches off from the primary transmission pattern 44a is seen as a base end side, the auxiliary transmission pattern 44b is formed such that the leading end side thereof is a dead end.

A linear portion 44ba having a substantially constant pattern width and a probe abutting portion 44bb at the leading end portion of the auxiliary transmission pattern 44b are formed in the auxiliary transmission pattern 44b. The probe abutting portion 44bb is provided to facilitate abutting of the leading end portion of the probe 202 and is formed to have a greater width than the linear portion 44ba, which is the other portion adjacent to the probe abutting portion 44bb in the auxiliary transmission path. In the present embodiment, the probe abutting portion 44bb is formed in a circular shape. In this manner, the auxiliary transmission pattern 44b is used to allow the probe 202 to make contact therewith.

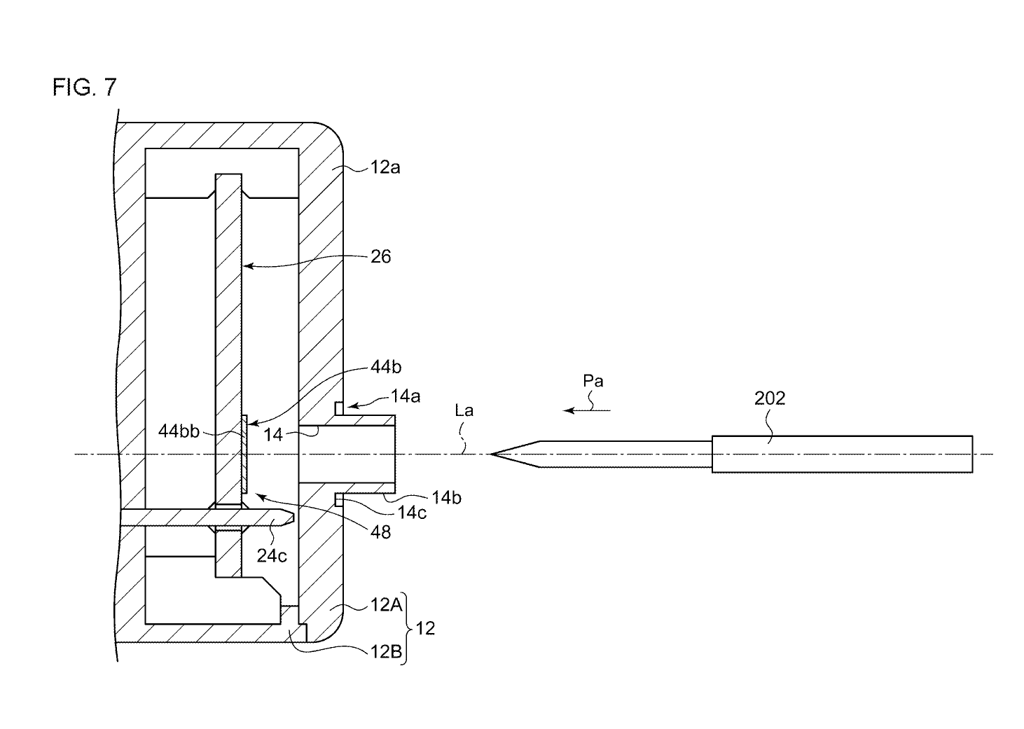

The probe insertion hole 14 will now be described. FIG. 7 is a sectional view illustrating the probe insertion hole 14 in the actuator 10.

As illustrated in FIGS. 3 and 7, the probe insertion hole 14 is formed, among the plurality of side surface portions 12a-12f of the housing 12, in the front side surface portion 12a on which the connector portion 12g is formed. The probe insertion hole 14 is formed on the front side surface portion 12a of the housing 12 at a position that is different from the position where the connector portion 12g is formed. The probe 202 to be used for the inspection of the actuator 10 can be inserted into the probe insertion hole 14 in the direction Pa. The probe 202 is for continuously taking out the detection signal of the rotation sensor 22 from the probe abutting portion 44bb of the auxiliary transmission pattern 44b that constitutes a portion of the transmission path 48 to which the detection signal is continuously transmitted.

On the front side surface portion 12a of the housing 12, a convex portion 14b is formed at a peripheral portion 14a of the probe insertion hole 14. The convex portion 14b is formed in a cylindrical shape that projects from the housing 12 toward the outside, and the inner side of the convex portion 14b forms a portion of the probe insertion hole 14. On the front side surface portion 12a of the housing 12, a concave portion 14c is formed around the root portion of the convex portion 14b that is on the side opposite to the direction in which the convex portion 14b projects. The concave portion 14c is dented in the direction opposite to the direction in which the convex portion 14b projects. The concave portion 14c is formed in a continuous annular groove shape that surrounds the root portion of the cylindrical convex portion 14b. The effects of the convex portion 14b and the concave portion 14c will be described later.

The probe abutting portion 44bb on the control board 26 described above is disposed at a position that is inside the housing 12 and that is disposed on a straight line La passing through the center axis of the probe insertion hole 14 so as to facilitate abutting of the probe 202. In other words, the probe abutting portion 44bb is disposed on the inner side of the housing 12 relative to the probe insertion hole 14. When viewed from another perspective, the probe abutting portion 44bb, which constitutes a portion of the transmission path 48, is disposed at a position at which the leading end portion of the probe 202 inserted in the probe insertion hole 14 can abut.

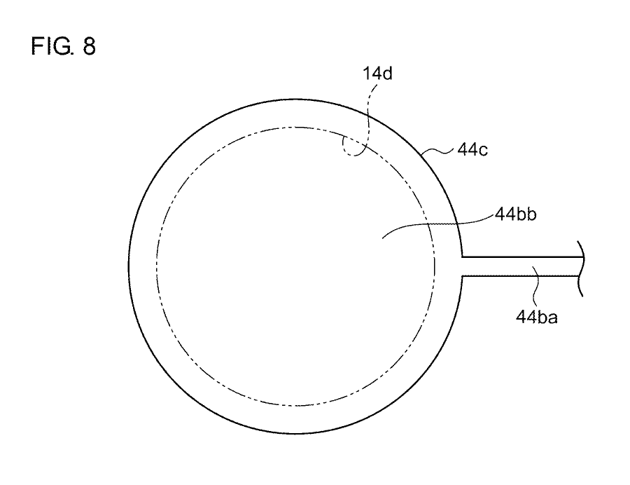

FIG. 8 illustrates the shape of the probe abutting portion 44bb, as viewed from one side (right side in FIG. 7) in the axial direction of the probe insertion hole 14.

The probe abutting portion 44bb is shaped such that, as viewed from one side in the axial direction of the probe insertion hole 14, an outline 14d of a cross-sectional shape of the probe insertion hole 14 orthogonal to the axial direction is fit inside an outline 44c of a surface shape of the probe abutting portion 44bb. This configuration makes it easier to dispose the probe abutting portion 44bb on the straight line La passing through the center axis of the probe insertion hole 14 even when an error, such as a dimension error or an assembly error, of the housing 12 or the like is present, and the probe 202 can be made to stably abut against the probe abutting portion 44bb with ease.

Now, an inspection method in which the above-described actuator 10 is used will be described.

This inspection is carried out for an assembled actuator 10. The assembled actuator 10″ as used herein refers to an actuator 10 obtained by containing the internal components, such as the electric motor 16, in the lower housing member 12B and then attaching the upper housing member 12A to the lower housing member 12B as illustrated in FIG. 3.

As illustrated in FIGS. 1 and 2, in the inspection method, an operator first inserts the external connector 204 of the inspection apparatus 200 into the connector portion 12g of the housing 12. Thus, the external control device 206 and the control portion 38 of the actuator 10 become electrically connected. This operation is for supplying power from the external control device 206 to the electric motor 16 and the rotation sensor 22 through the control portion 38 and for transmitting an operation instruction from the external control device 206 to the control portion 38.

The operator inserts the probe 202 into the probe insertion hole 14 of the housing 12 and brings the leading end portion of the probe 202 into contact with the probe abutting portion 44bb on the control board 26. Thus, the probe abutting portion 44bb of the actuator 10 and the probe 202 become having electrically continuity, and the probe abutting portion 44bb and the measuring device 210 become electrically connected through the probe 202.

The operator operates the external control device 206 to supply power from the external control device 206 to the electric motor 16 and the rotation sensor 22 through the control board 26. In addition, the operator operates the external control device 206 to transmit a rotational operation instruction for rotating the electric motor 16 from the external control device 206. Thus, the control portion 38 of the actuator 10 causes the electric motor 16 to operate in accordance with the rotational operation instruction so as to rotationally drive the output shaft 20.

While the output shaft 20 rotates, a detection signal generated by the rotation sensor 22 is continuously transmitted to the transmission path 48 including the auxiliary transmission pattern 44b. The detection signal continuously transmitted to the auxiliary transmission pattern 44b is continuously taken out to the measuring device 210 through the probe 202 from the probe abutting portion 44bb. Thus, the signal level of the detection signal can be measured continuously by the measuring device 210. The operator checks a temporal change in the signal level of the detection signal, and thus the output characteristics of the rotation sensor 22 can be inspected. At this time, the probe 202 takes out an analog-value detection signal generated by the rotation sensor 22, and the output characteristics of the rotation sensor 22 are inspected with the use of the analog-value detection signal. The measuring device 210 is provided with a display portion (not illustrated), such as gradations or the like, that displays the measurement result, and the operator can check the signal level of the detection signal through the content displayed on the display portion.

The effects of the actuator 10 and the inspection method described above will be described.

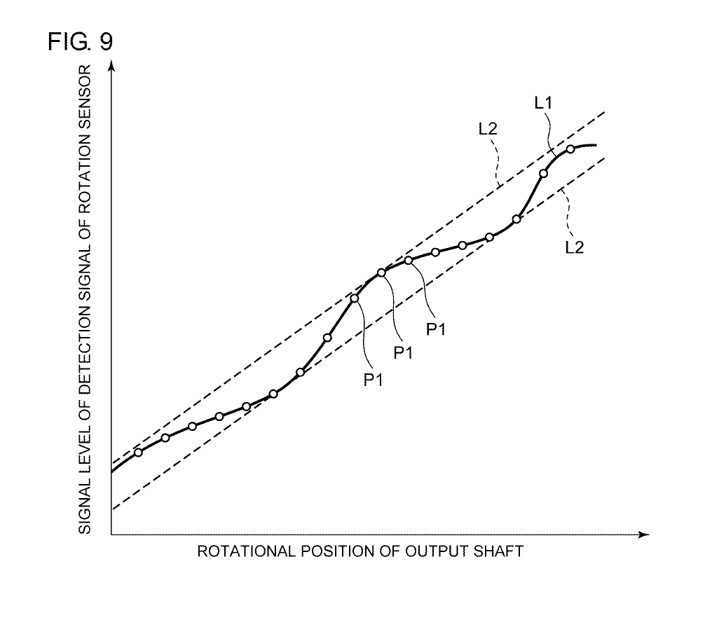

FIG. 9 is a graph illustrating a relationship between the rotational position of the output shaft 20 and the signal level of the detection signal of the rotation sensor 22. The solid line L1 indicated in FIG. 9 represents the measurement value obtained when the detection signal of the rotation sensor 22 is measured continuously. The points P1 indicated in FIG. 9 represent the measurement values obtained when the detection signal of the rotation sensor 22 is measured intermittently. In addition, the two dashed lines L2 indicated in FIG. 9 represent the reference lines for determining the quality of the output characteristics of the rotation sensor 22. The assumption for the point data indicated in FIG. 9 is that, after a rotational operation instruction is transmitted from the external control device 206, an operation instruction requesting for a current detection signal is transmitted from the external control device 206 at a constant interval. Thus, the external control device 206 can acquire the detection signal of the rotation sensor 22 through the communication line 208c, and the detection signal is measured intermittently.

(A) In the actuator 10 according to the present embodiment, the probe insertion hole 14 that can have the probe 202 inserted thereinto is formed in the housing 12. Thus, the detection signal of the rotation sensor 22 can be directly taken out from the transmission path 48 through the probe 202. Accordingly, the detection signal of the rotation sensor 22 can be measured continuously with respect to a temporal change, and the accuracy in inspecting the output characteristics of the rotation sensor 22 can be increased, as compared to a case in which the detection signal is measured intermittently with respect to a temporal change, as illustrated in FIG. 9.

(B) Consider a case in which the detection signal is taken out by transmitting an operation instruction requesting for a current detection signal from the external control device to the control portion 38 of the actuator 10, as described above. In this case, a method can be contemplated in which the number of measurement points is increased by increasing the number of transmitting the operation instruction in order to improve the inspecting accuracy of the output characteristics of the rotation sensor 22. However, in this case, increasing the number of transmitting the operation instruction causes increasing the number of processes required for the instruction operation, and an extended period of time is required for the inspection operation. In this respect, with the actuator 10 according to the present embodiment, the detection signal of the rotation sensor 22 can be measured continuously. Accordingly, the number of processes and the time required for the inspection operation can be reduced by reducing the number of transmitting the operation instruction from the external control device 206, and the accuracy for inspecting the output characteristics of the rotation sensor 22 can be improved.

In addition, the probe insertion hole 14 is formed in the housing 12 at a position different from the position where the connector portion 12g is formed. Thus, even if the probe insertion hole 14 is plugged up after the inspection operation is finished as described later, the external connector 204 can be detachably mounted to the connector portion 12g.

(C) The probe abutting portion 44bb is formed in the conductor pattern 44 that constitutes a portion of the transmission path 48, which makes it easier to have the leading end portion of the probe 202 inserted in the probe insertion hole 14 abut against the conductor pattern 44. Accordingly, an operation of bringing the probe 202 into contact with the conductor pattern 44 is facilitated, and the operability of the inspection operation improves.

(D) The probe abutting portion 44bb is formed in the conductor pattern 44 on the control circuit board 26, and thus a broader area can easily be secured for the probe abutting portion 44bb than in a case in which the probe abutting portion 44bb is formed in a terminal, such as the output sensor terminal 24c, that constitutes a portion of the transmission path 48. Accordingly, an operation of bringing the probe 202 into contact with the probe abutting portion 44bb is facilitated, and the operability of the inspection operation improves.

(E) The transmission path 48 includes, in addition to the primary transmission pattern 44a, the auxiliary transmission pattern 44b into which the probe 202 is brought into contact. Accordingly, the primary transmission pattern 44a does not need to make contact with the probe 202, and the inspection operation can be carried out by using the auxiliary transmission pattern 44b while the primary transmission pattern 44a is being protected from making contact with the probe 202.

In addition, consider a modification in which the probe insertion hole 14 is formed in the right side surface portion 12c (see FIG. 1), instead of the front side surface portion 12a, of the housing 12. In this case, when the external connector 204 is inserted into the connector portion 12g of the housing 12, the housing 12 should be held from the back side surface portion 12b, which is opposite to the front side surface portion 12a, of the housing 12 in order to prevent the actuator 10 from moving. In addition, when the probe 202 is inserted into the probe insertion hole 14 in the housing 12, the housing 12 should be held from the left side surface portion 12d (see FIG. 3), which is opposite to the right side surface portion 12c, of the housing 12 in order to prevent the actuator 10 from moving. In this manner, with the modification, the position that should be held varies between the time when the external connector 204 is inserted and the time when the probe 202 is inserted.

In contrast, according to the present embodiment, the connector portion 12g and the probe insertion hole 14 are formed in the front side surface portion 12a of the housing 12. Accordingly, when the external connector 204 and the probe 202 are inserted into the connector portion 12g and the probe insertion hole 14, respectively, the operation can be carried out while the housing 12 is held from the same position (the back side surface portion 12b of the housing 12), and the operability of the inspection operation improves.

A method of processing the above-described actuator 10 will now be described.

If the probe insertion hole 14 of the actuator 10 is left open after the inspection operation described above finishes, a foreign object, such as dust, may enter the housing 12 through the probe insertion hole 14 and affect the operation of the internal components in the housing 12.

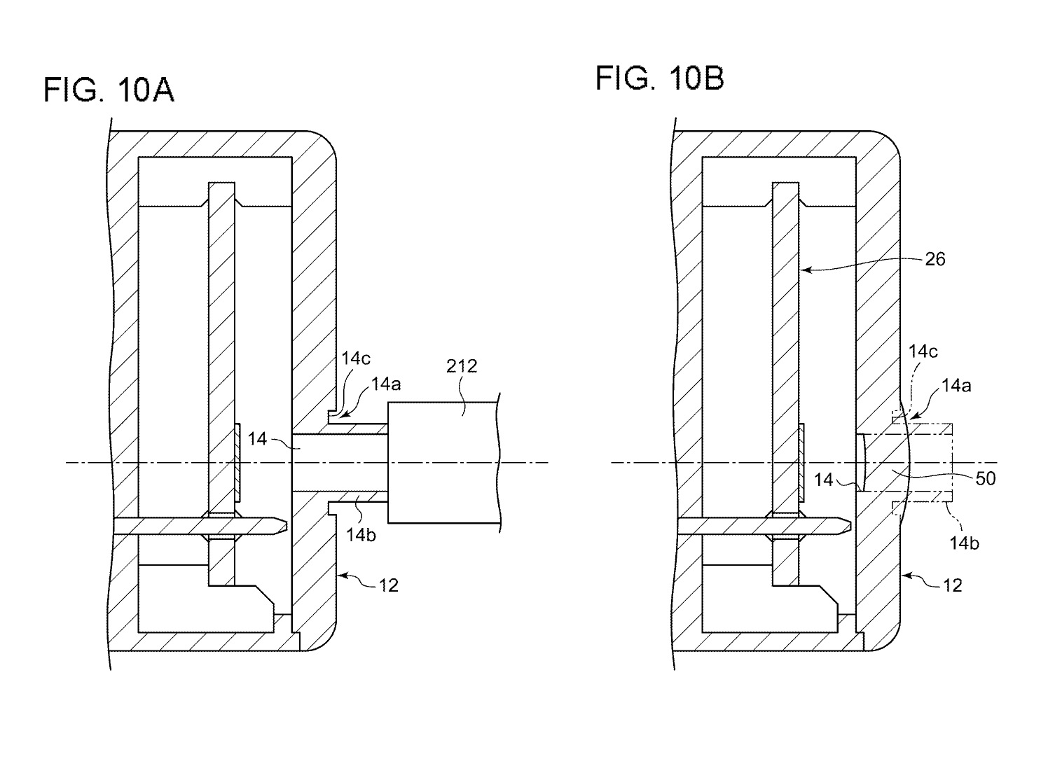

Therefore, in the processing method, as illustrated in FIG. 10A, the process of heating and melting the peripheral portion 14a of the probe insertion hole 14 of the housing 12 which constitutes a portion of the housing 12, and plugging up the probe insertion hole 14 with a molten resin is carried out. This process is carried out with the use of a heating device 212, such as a heated iron. The operator heats and melts a portion of the housing 12 by using the heating device 212 and guides the resulting molten resin to flow into the probe insertion hole 14. With this operation, a plugging body 50 that plugs up the probe insertion hole 14 is formed in the housing 12, as illustrated in FIG. 10B. The plugging body 50 is formed integrally with the peripheral portion 14a of the probe insertion hole 14 such that the plugging body 50 constitutes a portion of the housing 12.

According to this processing method, the probe insertion hole 14 of the housing 12 can be plugged up by the plugging body 50, and thus the internal components in the housing 12 can be protected from a foreign object, such as dust. In addition, the plugging body 50 is formed integrally with the peripheral portion of the probe insertion hole 14 in the housing 12, and thus a dedicated component for the plugging body 50 is not necessary. Accordingly, the number of components of the actuator 10 can be reduced, and thus the manufacturing cost can be reduced while the management of the components is simplified.

The convex portion 14b is formed at the peripheral portion of the probe insertion hole 14 of the housing 12, and thus the amount of material for plugging up the probe insertion hole 14 can be secured with ease. Accordingly, the probe insertion hole 14 can be plugged up by melting the peripheral portion 14a of the probe insertion hole 14 while the peripheral portion 14a of the probe insertion hole 14 is prevented from becoming excessively thin. It should be noted that, when the probe insertion hole 14 is to be plugged up, the convex portion 14b that constitutes a portion of the peripheral portion 14a of the housing 12 is heated and melted, and the resulting molten resin is made to flow into the probe insertion hole 14.

In addition, the concave portion 14c is formed in the front side surface portion 12a of the housing 12 at a portion surrounding the root portion of the convex portion 14b, and thus this configuration provides the following advantage. Consider a case in which the convex portion 14b is melted and the molten resin is made to flow into the probe insertion hole 14. In this case, the concave portion 14c serves a function of accepting the molten resin that is to flow around the probe insertion hole 14 instead of flowing into the probe insertion hole 14. This configuration can reduce the molten resin broadly spreading around the probe insertion hole 14 on the outer surface of the housing 12 and can make the appearance of the melted portion less noticeable after the probe insertion hole 14 is plugged up.

### Second Embodiment

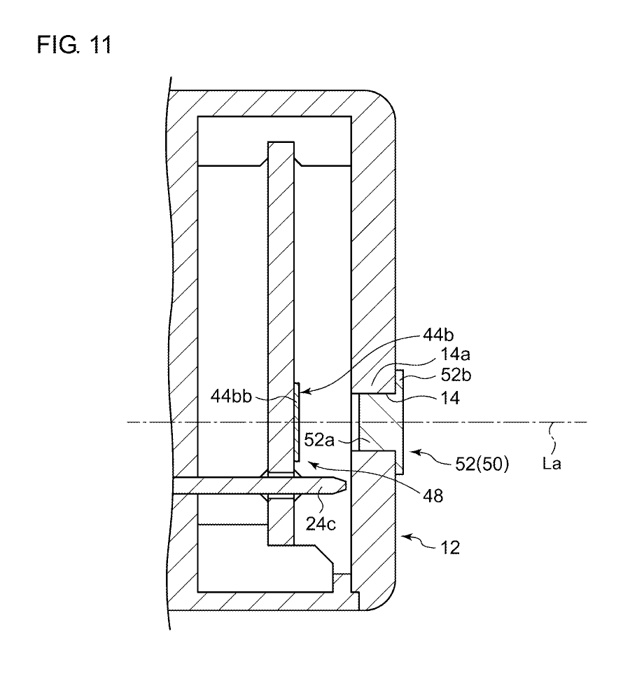

FIG. 11 is a sectional view illustrating an actuator 10 according to a second embodiment. FIG. 11 illustrates a section as viewed from the same viewpoint as that of FIG. 10B.

FIG. 10B illustrates an example in which the plugging body 50 for plugging the probe insertion hole 14 is constituted by a portion of the housing 12. Aside from this configuration, the plugging body 50 may be constituted by a lid member 52 that is separate from the housing 12. The lid member 52 includes a lid portion 52a that plugs up the probe insertion hole 14 and a head portion 52b that engages with the peripheral portion 14a of the probe insertion hole 14. The lid portion 52a of the lid member 52 is inserted into the probe insertion hole 14 from the outside of the housing 12 so as to plug up the probe insertion hole 14.

Although FIG. 10B illustrates an example in which the convex portion 14b and the concave portion 14c are formed at the peripheral portion of the probe insertion hole 14, the convex portion 14b and the concave portion 14c are not formed in the present example.

### Third Embodiment

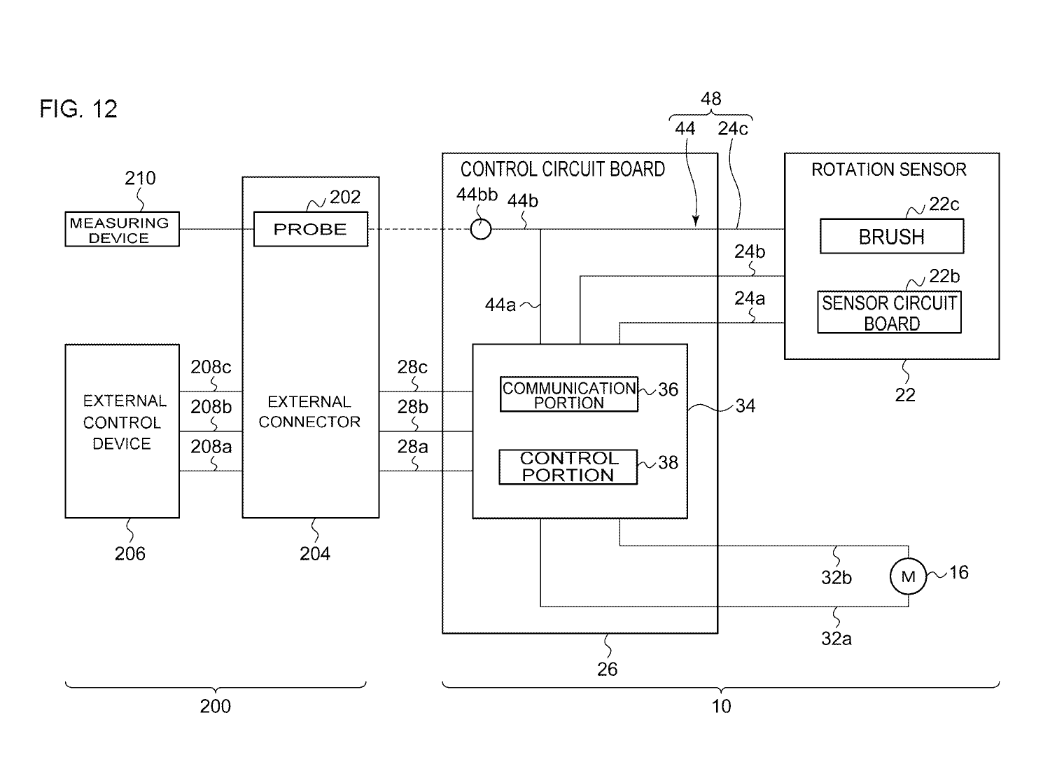

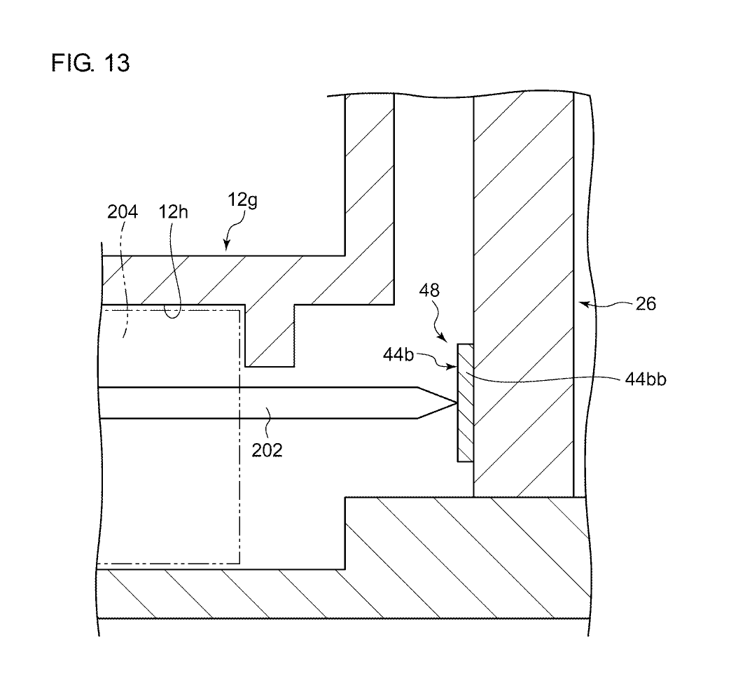

FIG. 12 is a block diagram illustrating functionality of an actuator 10 and an inspection apparatus 200 according to a third embodiment. FIG. 13 is a schematic diagram illustrating a configuration of a portion around the connector portion 12g of the actuator 10 according to the third embodiment.

The first embodiment describes an example in which an insertion hole into which the probe 202 is inserted is the probe insertion hole 14. The present embodiment differs from the first embodiment in that an insertion hole into which the probe 202 is inserted is the connector insertion hole 12h. Inside the housing 12, the control board 26 and the probe abutting portion 44bb of the auxiliary transmission pattern 44b that constitutes a portion of the transmission path 48 is disposed on the inner side of the housing 12 relative to the connector insertion hole 12h.

In addition to the ground line 208a, the power-supply line 208b, and the communication line 208c, the probe 202 is inserted into the external connector 204 of the inspection apparatus 200. The lines 208a-208c are omitted in FIG. 13. When the external connector 204 is mounted to the connector portion 12g of the housing 12, the lines 208a-208c become having electrically continuity with the connector terminals 28a-28c on the control board 26, and the leading end portion of the probe 202 makes contact with the probe abutting portion 44bb on the control board 26. With the actuator 10 according to the present embodiment as well, the effects similar to those in (A)-(E) described above can be obtained.

Thus far, the present invention has been described on the basis of the embodiments, but the embodiments merely describe the principle and the applications of the present invention. In addition, a number of modifications or arrangement changes can be made to the embodiments within the scope that does not depart from the spirit of the present invention set forth in the claims.

The actuator 10 may be used in an in-vehicle system, such as a vehicular air conditioning apparatus or a power window, or may be used for a purpose other than a vehicle. The electric motor 16 may be an AC motor, a servomotor, a stepping motor, or the like, instead of a DC motor. An example in which the control portion 38 and the communication portion 36 on the control board 26 are constituted by a single circuit element (IC chip 34) has been described. Alternatively, the control portion 38 and the communication portion 36 may be constituted by separate circuit elements.

An example in which the rotation sensor 22 is constituted by a potentiometer has been described. Alternatively, the rotation sensor 22 may be constituted by a rotary encoder or the like. In addition, although an example in which a sensor to be inspected is the rotation sensor 22 has been described, this is not a limiting example. For example, a sensor to be inspected may be a temperature sensor, a pressure sensor, a humidity sensor, or the like. In any case, a sensor to be inspected may be a sensor that detects a physical quantity.

An example in which the transmission path 48 capable of continuously transmitting a detection signal generated by the sensor includes the conductor patterns 42 and 44 on the control circuit board 26 has been described. The transmission path 48, however, is not limited to the conductor patterns and may be a terminal of the output sensor terminal 24c. This terminal is a molding made of conductor. When the transmission path 48 is a terminal, the probe abutting portion 44bb having a greater width than a portion of the terminal may be formed in adjacent to that portion. When the transmission path 48 is a terminal as well, a primary transmission path and an auxiliary transmission path may be formed. An example in which the transmission path 48 is formed outside the sensor has been described. Alternatively, the transmission path 48 may be formed inside the sensor. An example in which the probe abutting portion 44bb is formed at the leading end portion of the auxiliary transmission path has been described. Alternatively, the probe abutting portion 44bb may be formed at a position midway in the auxiliary transmission path or may be formed in the primary transmission path.

The measuring device 210 may be equipped with a function of carrying out determination processing of determining whether the signal level of a detection signal is within a predetermined range. In this case, the processing result of the determination processing may be displayed in the display portion of the measuring device 210, and thus the operator can check the signal level of the detection signal.

In the third embodiment, an example in which the probe 202 is inserted into the external connector 204 of the inspection apparatus 200 and the leading end portion of the probe 202 is brought into contact with the auxiliary transmission pattern 44b on the control board 26 so as to take out the detection signal of the sensor has been described. Aside from this configuration, a detection signal terminal for taking out a detection signal may be connected to the control board 26 or the like along with the other connector terminals 28a-28c, and the probe 202 in the external connector 204 may be brought into contact with this detection signal terminal so as to take out the detection signal of the sensor. In this case, the detection signal terminal constitutes a portion of the transmission path capable of continuously transmitting a detection signal of the sensor. In addition, to bring the detection signal terminal and the probe 202 in the external connector 204 into contact with each other, one of the two may be formed as a male terminal and the other one may be formed as a female terminal, and the two may be fitted together to retain their positions.

What is claimed is:

1. A motor actuator, comprising:
a housing that contains a motor;
a sensor contained in the housing; and
a transmission path capable of continuously transmitting a detection signal generated by the sensor,
wherein the housing has an insertion hole formed therein, the insertion hole being capable of receiving a probe for taking out the detection signal from the transmission path.

2. The motor actuator according to claim 1, wherein the housing has a connector portion formed therein to which an external connector can be mounted, and
wherein the insertion hole is formed in the housing at a position different from a position where the connector portion is formed.

3. The motor actuator according to claim 1, wherein a conductor constituting a portion of the transmission path has a probe abutting portion formed therein, the probe abutting portion having a greater width than another portion adjacent thereto in the transmission path.

4. The motor actuator according to claim 3, further comprising a circuit board contained in the housing,
wherein the portion of the transmission path is a conductor pattern formed on the circuit board, and
wherein the probe abutting portion is formed in the conductor pattern.

5. The motor actuator according to claim 1, further comprising
a circuit board on which a circuit element that processes the detection signal is mounted,
the transmission path including:
a primary transmission path for transmitting the detection signal from the sensor to the circuit element; and
an auxiliary transmission path formed by a portion that branches off from the primary transmission path and provided to allow the probe to make contact therewith.

6. The motor actuator according to claim 1, wherein the housing has a connector portion formed therein to which an external connector can be mounted, and
wherein the insertion hole is formed, among a plurality of side surface portions of the housing, in a side surface portion on which the connector portion is formed.

7. The motor actuator according to claim 1, further comprising
a plugging body that plugs up the insertion hole.

8. The motor actuator according to claim 7, wherein the plugging body is formed integrally with a peripheral portion of the insertion hole.

9. The motor actuator according to claim 1, wherein the housing has a convex portion formed at a peripheral portion of the insertion hole, the convex portion projecting toward the outside of the housing.

10. The motor actuator according to claim 2, wherein the housing has a convex portion formed at a peripheral portion of the insertion hole, the convex portion projecting toward the outside of the housing.

11. The motor actuator according to claim 1, further comprising:
a communication portion capable of transmitting and receiving data to and from an external control device through serial communication; and
a control portion that operates in accordance with an operation instruction transmitted from the external control device.

12. A method of processing a motor actuator, the method comprising:
plugging up the insertion hole by melting a portion of the housing of the motor actuator according to claim 1.

13. A method of processing a motor actuator, the method comprising:
plugging up the insertion hole by melting a portion of the housing of the motor actuator according to claim 10.

14. A method of inspecting the motor actuator according to claim 1, the method comprising:
bringing the probe inserted in the insertion hole into contact with the transmission path, and taking out, through the probe, a detection signal output continuously from the sensor.
